(19) United States
(12) Patent Application Publication
(10) Pub. No.: US 2026/0050696 A1
(43) Pub. Date: Feb. 19, 2026

(54) SELF-FILTERING MONOSTABLE PUF CIRCUIT BASED ON HYSTERESIS EFFECT

(71) Applicant: Wenzhou University, Zhejiang (CN)

(72) Inventors: Gang LI, Zhejiang (CN); Pengjun WANG, Zhejiang (CN); Ruize Xu, Zhejiang (CN); Hao Ye, Zhejiang (CN); Xilong Shao, Zhejiang (CN)

(73) Assignee: Wenzhou University, Zhejiang (CN)

(21) Appl. No.: 19/026,581

(22) Filed: Jan. 17, 2025

(30) Foreign Application Priority Data
Aug. 16, 2024 (CN) 202411124498.2

(51) Int. Cl. G06F 21/75; H03K 17/687

(52) U.S. Cl. CPC G06F 21/75; H03K 17/6872

(57) ABSTRACT

A self-filtering monostable PUF circuit based on hysteresis effect is provided. The self-filtering monostable PUF circuit includes a PUF unit array formed by n×m PUF units distributed in n rows and m columns, wherein n and m are integers greater than or equal to 1. By adding a filter unit based on a Schmitt trigger, the self-filtering monostable PUF circuit utilizes the hysteresis effect of the Schmitt trigger to efficiently self-filter the PUF units with unstable outputs to improve the overall stability of the PUF circuit. The advantage of high stability is achieved.

### CROSS-REFERENCE TO RELATED APPLICATION

This application claims the priority benefit of China application serial no. 202411124498.2, filed on Aug. 16, 2024. The entirety of the above-mentioned patent application is hereby incorporated by reference herein and made a part of this specification.

### BACKGROUND

### Technical Field

The present disclosure relates to a PUF circuit and, in particular, to a self-filtering monostable PUF circuit based on hysteresis effect.

### Description of Related Art

In the digital era, security becomes the core focus in the field of information technology. As a reliable hardware security primitive, the physical unclonable function (PUF) has developed rapidly. Based on inherent and unpredictable physical differences in the manufacturing process of integrated circuits (ICs), a PUF circuit gives each IC a unique “fingerprint”. These physical differences may be small changes in device parameters, such as the threshold voltage, resistance value, or capacitance value of transistors. Based on these small physical differences, the PUF circuit generates a specific series of responses to distinguish between different ICs, thus providing a unique identifier for a hardware device. The emergence of PUF circuits marks the transition from traditional key storage and management methods to more dynamic and secure key generation and authentication mechanisms. Compared with the traditional key storage solutions, the PUF circuit does not need to store keys in devices, dynamically generate keys based on the characteristics of the hardware itself, greatly enhancing the security of integrated circuits.

PUF circuits can be classified as monostable PUF circuits and bistable PUF circuits according to the number of output states of PUF units in their internal PUF unit arrays. Due to the PUF units therein only having one stable output state, the monostable PUF circuits are usually used in low-power devices and resource-constrained environments. However, the PUF units in conventional monostable PUF circuits usually generate an entropy source by short-circuiting the input and output of amplifiers, and amplifies and extracts the entropy source by connecting multiple amplifiers in series to obtain PUF responses. Inevitably, the output voltage of some entropy sources is located near the amplifier switching voltage. When the voltage and temperature fluctuate, the output voltage of the entropy sources will shift, and the extracted PUF responses will change, leading to the stability problem of the monostable PUF circuit.

### SUMMARY

The technical problem to be solved by the present disclosure is to provide a high-stability self-filtering monostable PUF circuit based on hysteresis effect.

The technical solution adopted by the present disclosure to solve the above technical problem is: a self-filtering monostable PUF circuit based on hysteresis effect, comprising a PUF unit array formed by n×m PUF units distributed in n rows and m columns, wherein n and m are integers greater than or equal to 1. By adding a filter unit based on a Schmitt trigger, the self-filtering monostable PUF circuit utilizes the hysteresis effect of the Schmitt trigger to efficiently self-filter the PUF units with unstable outputs to improve the overall stability of the PUF circuit.

The filter unit comprises a first inverter, a second inverter, a third inverter, a 2-to-1 data selector and a Schmitt trigger, wherein each of the first inverter, the second inverter and the third inverter has an input terminal and an output terminal; the 2-to-1 data selector has two input terminals respectively referred as a first input terminal and a second input terminal, an output terminal and a timing control terminal; the Schmitt trigger has an input terminal and an output terminal; the input terminal of the first inverter is connected to the second input terminal of the 2-to-1 data selector, and a connection terminal thereof serves as an input terminal of the filter unit; the input terminal of the filter unit is configured to receive output responses generated by the PUF units; the output terminal of the first inverter is connected to the input terminal of the second inverter, the output terminal of the second inverter is connected to the input terminal of the third inverter, the output terminal of the third inverter is connected to the first input terminal of the 2-to-1 data selector; the output terminal of the 2-to-1 data selector is connected to the input terminal of the Schmitt trigger; the output terminal of the Schmitt trigger serves as an output terminal of the filter unit and the output terminal of the filter unit is configured to output a filter result; the timing control terminal of the 2-to-1 data selector serves as a timing control terminal of the filter unit to receive a high-level or low-level timing control signal.

The self-filtering monostable PUF circuit based on hysteresis effect further comprises an input register, a timing controller, a row decoder, a column decoder and a transmission gate array, wherein the input register is configured to pre-store required row address data and column address data; the timing controller has an output terminal and is configured to generate a high-level timing control signal or a low-level timing control signal and output the signal via the output terminal thereof; the output terminal of the timing controller is connected to the timing control terminal of the filter unit; the row decoder has an input terminal and n-bit output terminals; the input terminal of the row decoder is connected to the input register to receive the row address data; the row decoder is configured to convert the row address data received by the input terminal thereof into n-bit row selection signals and output the n-bit row selection signals via the n-bit output terminals thereof in a one-to-one correspondence, wherein only one bit in the n-bit row selection signals is a high-level signal, and the other are low-level signals; the column decoder has an input terminal and m-bit output terminals, the input terminal of the column decoder is connected to the input register, the column address data is input in the input terminal of the column decoder, and the column decoder is configured to convert the column address data received by the input terminal thereof into m-bit column selection signals and output the m-bit column selection signals via the m-bit output terminals thereof in a one-to-one correspondence, wherein only one bit in the m-bit column selection signals is a high-level signal, and the other are low-level signals; the transmission gate array is formed by (n+1)×m transmission gates distributed in n+1 rows and m columns, each of the transmission gates has an input terminal, an output terminal and a control terminal, and under the control of a control signal received by the control terminal of the transmission gate, the input terminal and output terminal thereof are turned on or off; each of the PUF units has an output terminal for outputting the output response thereof, the kth bit output terminal of the row decoder is connected to the control terminal of m transmission gates located in row k, k=1, 2, . . . , n, the jth bit output terminal of the column decoder is connected to the control terminal of the transmission gate located in row n+1 and column j, j=1, 2, . . . , m, the output terminal of the PUF unit located in row k and column j is connected to the input terminal of the transmission gate located in row k and column j, the output terminals of the n transmission gates located in rows 1 to n and column j are all connected to the input terminal of the transmission gate located in row n+1 and column j, and the output terminals of m transmission gates located in row n+1 are all connected to the input terminal of the filter unit.

Each of the PUF units comprises a first MOS, a second MOS, a third MOS and a fourth MOS, wherein the first MOS and the third MOS are PMOSs; the second MOS and the fourth MOS are NMOSs; the source of the first MOS and the source of the third MOS are connected to a power voltage (VDD); the drain and gate of the first MOS, the drain and gate of the second MOS, the gate of the third MOS and the gate of the fourth MOS are connected; the drain of the third MOS is connected to the drain of the fourth MOS, and a connection terminal thereof is the output terminal of the PUF unit; the source of the second MOS and the source of the fourth MOS are grounded; the first MOS and the second MOS constitute a first-stage inverter, and the third MOS and the fourth MOS constitute a second-stage inverter.

Each of the transmission gates comprises a fifth MOS, a sixth MOS, a seventh MOS and an eighth MOS, wherein the fifth MOS and the seventh MOS are PMOSs; the sixth MOS and the eighth MOS are NMOSs; the source of the fifth MOS is connected to the source of the sixth MOS, and a connection terminal thereof is the input terminal of the transmission gate; the drain of the fifth MOS is connected to the drain of the sixth MOS and a connection terminal thereof is the output terminal of the transmission gate; the gate of the fifth MOS, the drain of the seventh MOS and the drain of the eighth MOS are connected; the gate of the sixth MOS, the gate of the seventh MOS and the gate of the eighth MOS are connected, and a connection terminal thereof is the control terminal of the transmission gate; the source of the eighth MOS is grounded; the source of the seventh MOS is connected to the power voltage (VDD).

The Schmitt trigger comprises a ninth MOS, a tenth MOS, an eleventh MOS, a twelfth MOS, a thirteenth MOS and a fourteenth MOS, wherein the ninth MOS, the tenth MOS and the thirteenth MOS are PMOSs; the eleventh MOS, the twelfth MOS and the fourteenth MOS are NMOSs; the source of the ninth MOS is connected to the power voltage (VDD); the gate of the ninth MOS, the gate of the tenth MOS, the gate of the eleventh MOS and the gate of the twelfth MOS are connected, and a connection terminal thereof is the input terminal of the Schmitt trigger; the drain of the ninth MOS, the source of the tenth MOS and the source of the thirteenth MOS are connected; the drain of the thirteenth MOS is grounded; the drain of the tenth MOS, the drain of the eleventh MOS, the gate of the thirteenth MOS and the gate of the fourteenth MOS are connected, and a connection terminal thereof is the output terminal of the Schmitt trigger; the source of the eleventh MOS, the drain of the twelfth MOS and the source of the fourteenth MOS are connected; the source of the twelfth MOS is grounded; the drain of the fourteenth MOS is connected to the power voltage (VDD).

Compared with the prior art, the present disclosure has the following advantages. By adding a filter unit based on a Schmitt trigger, utilizing the hysteresis effect of the Schmitt trigger to efficiently self-filter PUF units with unstable outputs. The filter unit can filter out unstable PUF units, thereby discarding the extracted values of output responses generated by the unstable PUF units, and only saving the extracted values of output responses generated by stable PUF units. In this way, high stability is ensured.

### BRIEF DESCRIPTION OF THE DRAWINGS

FIG. 1 is a circuit diagram of a filter unit of a self-filtering monostable PUF circuit based on hysteresis effect according to the present disclosure;

FIG. 2 is a structural block diagram of the self-filtering monostable PUF circuit based on hysteresis effect according to the present disclosure;

FIG. 3 is a circuit diagram of PUF units of the self-filtering monostable PUF circuit based on hysteresis effect according to the present disclosure;

FIG. 4 is a circuit diagram of a transmission gate of the self-filtering monostable PUF circuit based on hysteresis effect according to the present disclosure;

FIG. 5 is a circuit diagram of a Schmitt trigger of the self-filtering monostable PUF circuit based on hysteresis effect according to the present disclosure;

FIG. 6 is a layout of a PUF units of the self-filtering monostable PUF circuit based on hysteresis effect according to the present disclosure;

FIG. 7 is a flow chart of the self-filtering monostable PUF circuit based on hysteresis effect according to the present disclosure for filtering unstable PUF units;

FIG. 8 is a grayscale diagram of PUF response output by the self-filtering monostable PUF circuit based on hysteresis effect according to the present disclosure;

FIG. 9 is a simulation diagram of intra-chip Hamming distance and inter-chip Hamming distance of the self-filtering monostable PUF circuit based on hysteresis effect according to the present disclosure;

FIG. 10 shows the native BER and the BER after filtering of the self-filtering monostable PUF circuit based on the hysteresis effect according to the present invention under the condition that the power voltage VDD is 1.0V and the ambient temperature is between −40° C. and 120° C.;

FIG. 11 shows the native BER and the BER after filtering of the self-filtering monostable PUF circuit based on the hysteresis effect according to the present invention under the condition that the power voltage VDD is 1.1V and the ambient temperature is between −40° C. and 120° C.;

FIG. 12 shows the native BER and the BER after filtering of the self-filtering monostable PUF circuit based on the hysteresis effect according to the present invention under the condition that the power voltage VDD is 1.2V and the ambient temperature is between −40° C. and 120° C.;

FIG. 13 shows the native BER and the BER after filtering of the self-filtering monostable PUF circuit based on the hysteresis effect according to the present invention under the condition that the power voltage VDD is 1.3V and the ambient temperature is between −40° C. and 120° C.;

FIG. 14 shows the native BER and the BER after filtering of the self-filtering monostable PUF circuit based on the hysteresis effect according to the present invention under the condition that the power voltage VDD is 1.4V and the ambient temperature is between −40° C. and 120° C.;

FIG. 15 shows the improvement in BER of the self-filtering monostable PUF circuit based on hysteresis effect according to the present disclosure under extreme conditions.

### DESCRIPTION OF THE EMBODIMENTS

The present disclosure is further described below in conjunction with accompanying drawings and embodiments.

Embodiment 1: A self-filtering monostable PUF circuit based on hysteresis effect comprises a PUF unit array formed by n×m PUF units distributed in n rows and m columns, wherein n and m are integers greater than or equal to 1. By adding a filter unit based on a Schmitt trigger U1, the self-filtering monostable PUF circuit utilizes the hysteresis effect of the Schmitt trigger U1 to efficiently self-filter the PUF units with unstable outputs to improve the overall stability of the PUF circuit.

In this embodiment, the filter unit can filter out unstable PUF units, thereby discarding the extracted values of output responses generated by the unstable PUF units, and only saving the extracted values of output responses generated by stable PUF units. In this way, high stability is ensured.

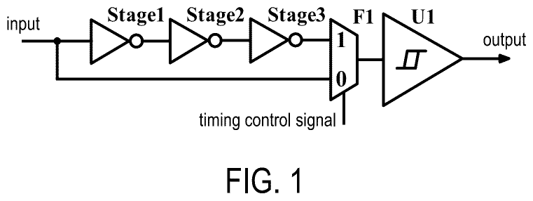

Embodiment 2: This embodiment is basically the same as Embodiment 1 but differs in the following way: in this embodiment, as shown in FIG. 1, the filter unit comprises a first inverter Stage1, a second inverter Stage2, a third inverter Stage3, a 2-to-1 data selector F1 and a Schmitt trigger U1, wherein each of the first inverter Stage1, the second inverter Stage2 and the third inverter Stage3 has an input terminal and an output terminal; the 2-to-1 data selector F1 has two input terminals respectively referred as a first input terminal and a second input terminal, an output terminal and a timing control terminal; the Schmitt trigger U1 has an input terminal and an output terminal; the input terminal of the first inverter Stage1 is connected to the second input terminal of the 2-to-1 data selector F1, and the connection terminal thereof serves as an input terminal of the filter unit; the input terminal of the filter unit is configured to receive output responses generated by the PUF units; the output terminal of the first inverter Stage1 is connected to the input terminal of the second inverter Stage2, the output terminal of the second inverter Stage2 is connected to the input terminal of the third inverter Stage3, the output terminal of the third inverter Stage3 is connected to the first input terminal of the 2-to-1 data selector F1; the output terminal of the 2-to-1 data selector F1 is connected to the input terminal of the Schmitt trigger U1; the output terminal of the Schmitt trigger U1 serves as an output terminal of the filter unit and the output terminal of the filter unit is configured to output a filter result; the timing control terminal of the 2-to-1 data selector F1 serves as a timing control terminal of the filter unit to receive a high-level or low-level timing control signal.

In this embodiment, for a stable PUF unit, its output voltage (i.e., an output response) is distributed near a low level or a high level; for an unstable PUF unit, its output voltage thereof is still distributed near the inverter switching voltage. By selecting the MOSs of an appropriate size in the Schmitt trigger, specific threshold voltages VT+ and VT− are obtained, so that the output voltage distribution range of the unstable PUF unit falls into a hysteresis interval. When the timing control signal=1, the output response of a PUF unit is transmitted to the filter unit, then amplified by the first inverter Stage1, the second inverter Stage2, and the third inverter Stage3, and then transmitted to the input terminal of the Schmitt trigger through the 2-to-1 data selector F1. Since the output response of the PUF unit has only two possibilities after being amplified by the first inverter Stage1, the second inverter Stage2, and the third inverter Stage3: high level or low level, a flip process of the Schmitt trigger will be selected. Then, the switching timing control signal=0, the output response of the PUF unit is transmitted to the filter unit and then directly transmitted to the input terminal of the Schmitt trigger through the 2-to-1 data selector F1. For a stable PUF unit, its output voltage is distributed near a high level or a low level, avoiding the hysteresis interval of the Schmitt trigger. Since the previous input signal of the Schmitt trigger is the output response of the PUF unit amplified by the first inverter Stage1, the second inverter Stage2 and the third inverter Stage3, and the current input signal is the output response of the PUF unit, the two signals are in different level intervals, which will cause the output of the Schmitt trigger to flip. For an unstable PUF unit, its output voltage falls into the hysteresis interval of the Schmitt trigger, and the output of the Schmitt trigger remains unchanged.

In this embodiment, when an output response generated by a PUF unit is input in the input terminal of the filter unit, a high-level timing control signal is input in the timing control terminal of the filter unit so that the first input terminal of the 2-to-1 data selector F1 is connected to the output terminal of the 2-to-1 data selector F1 and in this case, the output response input in the input terminal of the filter unit is inverted in sequence by the first inverter Stage1, the second inverter Stage2, and the third inverter Stage3 and then transmitted to the Schmitt trigger U1. The Schmitt trigger U1 extracts the signal transmitted thereto, obtains an extracted value of the output response and outputs the extracted value via the output terminal thereof. Then, the timing control signal of a low level is input in the timing control terminal of the filter unit so that the second input terminal of the 2-to-1 data selector F1 is connected to the output terminal of the 2-to-1 data selector F1 and in this case, the output response input in the input terminal of the filter unit is transmitted to the Schmitt trigger U1 via the output terminal of the 2-to-1 data selector F1. The Schmitt trigger U1 extracts the output response and obtains a determined value of the output response and outputs the determined value via the output terminal thereof. In this case, if the determined value of the output response is not equal to the extracted value, the currently generated output response is stable, the PUF unit that generates the output response is a stable PUF unit, and the extracted value of the output response is saved as a stable PUF response; if the determined value of the output response is equal to the extracted value, the currently generated output response is unstable, the PUF unit that generates the output response is an unstable PUF unit, and the extracted value of the output response is discarded as an unstable PUF response.

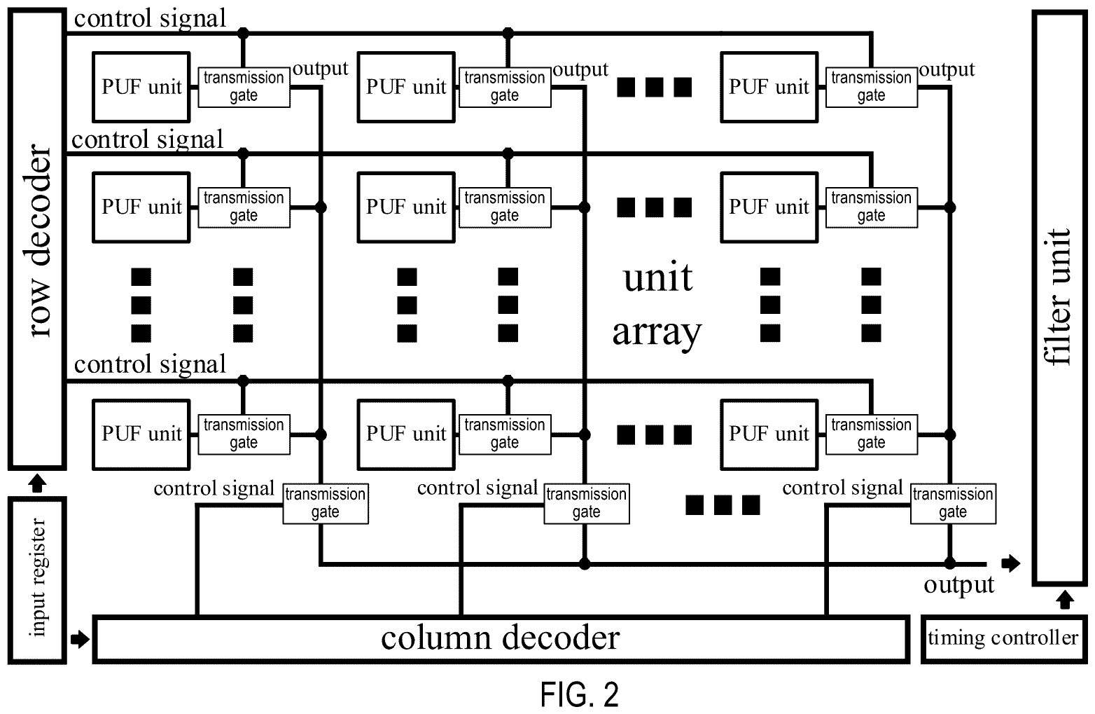

Embodiment 3: This embodiment is basically the same as embodiment 2 but differs in the following way: in this embodiment, as shown in FIG. 2, the self-filtering monostable PUF circuit based on hysteresis effect further comprises an input register, a timing controller, a row decoder, a column decoder and a transmission gate array, wherein the input register is configured to pre-store required row address data and column address data; the timing controller has an output terminal and is configured to generate a high-level timing control signal or a low-level timing control signal and output the signal via the output terminal thereof, the output terminal of the timing controller is connected to the timing control terminal of the filter unit; the row decoder has an input terminal and n-bit output terminals; the input terminal of the row decoder is connected to the input register to receive the row address data; the row decoder is configured to convert the row address data received by the input terminal thereof into n-bit row selection signals and output the n-bit row selection signals via the n-bit output terminals thereof in a one-to-one correspondence, wherein only one bit in the n-bit row selection signals is a high-level signal, and the other are low-level signals; the column decoder has an input terminal and m-bit output terminals, the input terminal of the column decoder is connected to the input register, the column address data is input in the input terminal of the column decoder, and the column decoder is configured to convert the column address data received by the input terminal thereof into m-bit column selection signals and output the m-bit column selection signals via the m-bit output terminals thereof in a one-to-one correspondence, wherein only one bit in the m-bit column selection signals is a high-level signal, and the other are low-level signals; the transmission gate array is formed by (n+1)×m transmission gates distributed in n+1 rows and m columns, each of the transmission gates has an input terminal, an output terminal and a control terminal, and under the control of a control signal received by the control terminal of the transmission gate, the input terminal and output terminal thereof are turned on or off, each of the PUF units has an output terminal for outputting the output response thereof, the kth bit output terminal of the row decoder is connected to the control terminal of m transmission gates located in row k (k=1, 2, . . . , n), the jth bit output terminal of the column decoder is connected to the control terminal of the transmission gate located in row n+1 and column j j=1, 2, . . . , m), the output terminal of the PUF unit located in row k and column j is connected to the input terminal of the transmission gate located in row k and column j, the output terminals of the n transmission gates located in rows 1 to n and column j are all connected to the input terminal of the transmission gate located in row n+1 and column j, and the output terminals of the m transmission gates located in row n+1 are all connected to the input terminal of the filter unit.

In this embodiment, when all PUF units in the PUF unit array generate output responses and output the output responses at the output terminals thereof, a piece of row address data and a piece of column address data in the input register are output to the row decoder and the column decoder, respectively. The row decoder converts the row address data output thereto into n-bit row selection signals and outputs the n-bit row selection signals to m transmission gates in the first row and to m transmission gates in row n via the n-bit output terminals thereof in a one-to-one correspondence. The column decoder converts the column address data output thereto into m-bit column selection signals and outputs the m-bit column selection signals to m transmission gates in row n+1 via the m-bit output terminals thereof in a one-to-one correspondence. In this case, all the m transmission gates in a row in which a high level is input are turned on, each transmission gate in the row outputs the output response generated by the PUF unit connected thereto via the output terminal thereof, one of the m transmission gates in row n+1 that receives a high level is turned on, and the transmission gate outputs the output response received by the input terminal thereof to the input terminal of the filter unit via the output terminal thereof. When an output response is input in the input terminal of the filter unit, the timing controller outputs a high-level timing control signal via the output terminal thereof, so that the first input terminal of the 2-to-1 data selector F1 is connected to the output terminal of the 2-to-1 data selector F1 and in this case, the output response received by the input terminal of the filter unit is inverted by the first inverter Stage1, the second inverter Stage2 and the third inverter Stage3 in sequence and then transmitted to the Schmitt trigger U1. The Schmitt trigger U1 extracts the signal transmitted thereto and obtains an extracted value of the output response and outputs the extracted value via the output terminal thereof. Then, the timing controller outputs a low-level timing control signal via the output terminal thereof, so that the second input terminal of the 2-to-1 data selector F1 is connected to the output end of the 2-to-1 data selector F1 and in this case, the output response received by the input terminal of the filter unit is transmitted to the Schmitt trigger U1 via the output terminal of the 2-to-1 data selector F1. The Schmitt trigger U1 extracts the output response and obtains a determined value of the output response and outputs the determined value via the output terminal thereof. In this case, if the determined value of the output response is not equal to the extracted value, the currently generated output response is stable, the PUF unit that generates the output response is a stable PUF unit, and the extracted value of the output response is saved as a stable PUF response; if the determined value of the output response is equal to the extracted value, the currently generated output response is unstable, the PUF unit that generates the output response is an unstable PUF unit, and the extracted value of the output response is discarded as an unstable PUF response, thus completing a round of extraction and stability detection of the output responses of the PUF units. Afterwards, next row address data in the input register is output to the row decoder, and next column address data is output to the column decoder, and next round of extraction and stability detection of the output responses of the PUF units begins, and this cycle is repeated until a required number of stable PUF responses are obtained.

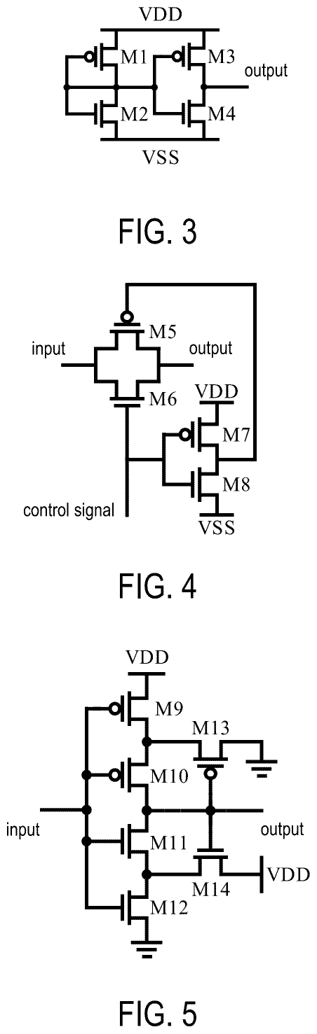

Embodiment 4: This embodiment is basically the same as Embodiment 3 but differs in the following way: in this embodiment, as shown in FIG. 3, each of the PUF units comprises a first MOS M1, a second MOS M2, a third MOS M3 and a fourth MOS M4, wherein the first MOS M1 and the third MOS M3 are PMOSs; the second MOS M2 and the fourth MOS M4 are NMOSs; the source of the first MOS M1 and the source of the third MOS M3 are connected to a power voltage VDD; the drain and gate of the first MOS M1, the drain and gate of the second MOS M2, the gate of the third MOS M3 and the gate of the fourth MOS M4 are connected; the drain of the third MOS M3 is connected to the drain of the fourth MOS M4, and the connection terminal thereof is the output terminal of the PUF unit; the source of the second MOS M2 and the source of the fourth MOS M4 are grounded; the first MOS M1 and the second MOS M2 constitute a first-stage inverter, and the third MOS M3 and the fourth MOS M4 constitute a second-stage inverter.

Embodiment 5: This embodiment is basically the same as Embodiment 3 but differs in the following way: in this embodiment, as shown in FIG. 4, each of the transmission gates comprises a fifth MOS M5, a sixth MOS M6, a seventh MOS M7 and an eighth MOS M8, wherein the fifth MOS M5 and the seventh MOS M7 are PMOSs; the sixth MOS M6 and the eighth MOS M8 are NMOSs; the source of the fifth MOS M5 is connected to the source of the sixth MOS M6, and the connection terminal thereof is the input terminal of the transmission gate; the drain of the fifth MOS M5 is connected to the drain of the sixth MOS M6 and the connection terminal thereof is the output terminal of the transmission gate; the gate of the fifth MOS M5, the drain of the seventh MOS M7 and the drain of the eighth MOS M8 are connected; the gate of the sixth MOS M6, the gate of the seventh MOS M7 and the gate of the eighth MOS M8 are connected, and the connection terminal thereof is the control terminal of the transmission gate; the source of the eighth MOS M8 is grounded; the source of the seventh MOS M7 is connected to the power voltage VDD.

Embodiment 6: This embodiment is basically the same as Embodiment 3 but differs in the following way: in this embodiment, as shown in FIG. 4, the Schmitt trigger U1 comprises a ninth MOS M9, a tenth MOS M10, an eleventh MOS M11, a twelfth MOS M12, a thirteenth MOS M13 and a fourteenth MOS M14, wherein the ninth MOS M9, the tenth MOS M10 and the thirteenth MOS M13 are PMOSs; the eleventh MOS M11, the twelfth MOS M12 and the fourteenth MOS M14 are NMOSs; the source of the ninth MOS M9 is connected to the power voltage VDD; the gate of the ninth MOS M9, the gate of the tenth MOS M10, the gate of the eleventh MOS M11 and the gate of the twelfth MOS M12 are connected, and the connection terminal thereof is the input terminal of the Schmitt trigger U1; the drain of the ninth MOS M9, the source of the tenth MOS M10 and the source of the thirteenth MOS M13 are connected; the drain of the thirteenth MOS M13 is grounded; the drain of the tenth MOS M10, the drain of the eleventh MOS M11, the gate of the thirteenth MOS M13 and the gate of the fourteenth MOS M14 are connected, and the connection terminal thereof is the output terminal of the Schmitt trigger U1; the source of the eleventh MOS M11, the drain of the twelfth MOS M12 and the source of the fourteenth MOS M14 are connected; the source of the twelfth MOS M12 is grounded; the drain of the fourteenth MOS M14 is connected to the power voltage VDD.

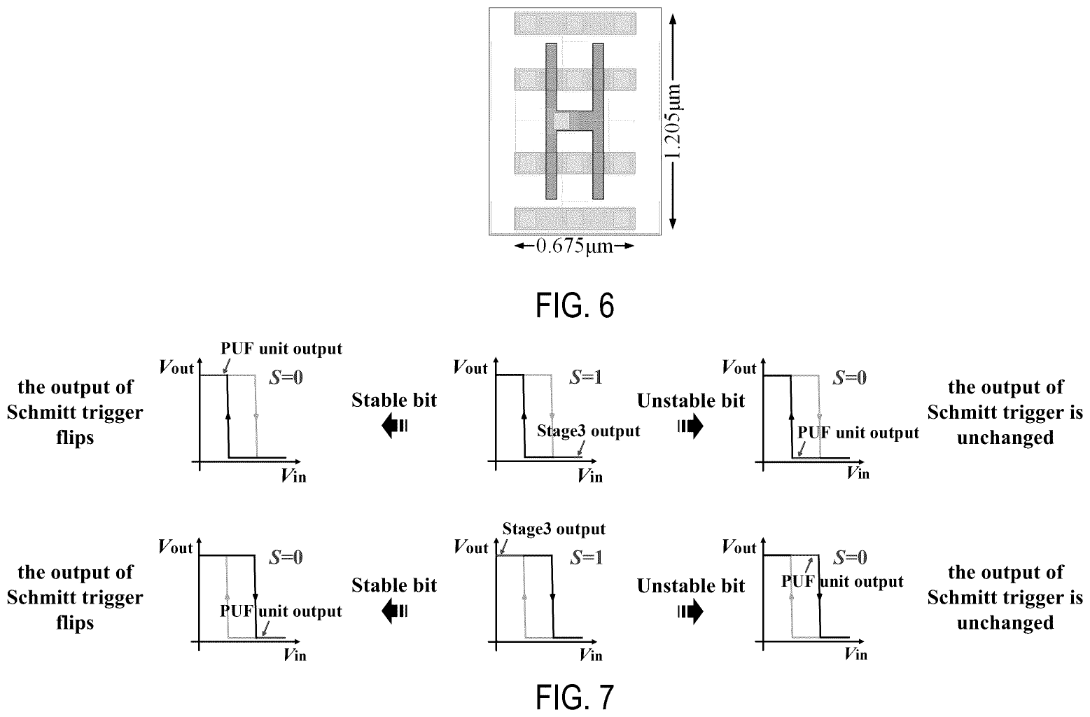

The layout of a PUF unit of the self-filtering monostable PUF circuit based on hysteresis effect according to the present disclosure is shown in FIG. 6. From FIG. 6, it can be seen that the PUF unit is 1.205 μm long and 0.675 μm wide, with a small area overhead.

The flow chart of the self-filtering monostable PUF circuit based on hysteresis effect according to the present disclosure for filtering unstable PUF units is shown in FIG. 7.

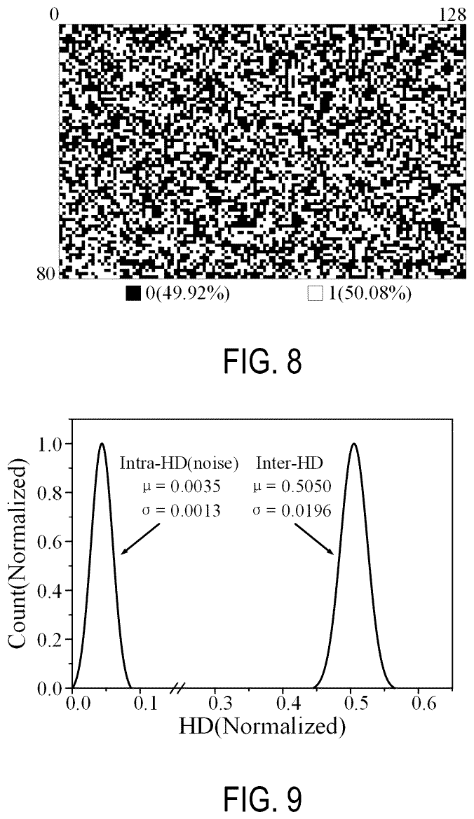

Randomness is an important characteristic of the PUF, and it means that the generated challenge-response pairs (CRPs) have random distribution of “0” and “1”. The randomness of the PUF is crucial to ensure the unpredictability of PUF responses. An ideal PUF circuit should have equal probability of outputting 0 and 1, i.e., 50% each. Usually, a two-dimensional grayscale image is a direct way to observe randomness. FIG. 8 shows a grayscale image of 10240-bit CRPs generated by the self-filtering monostable PUF circuit based on hysteresis effect according to the present invention under 20 different Monte Carlo conditions, where black pixels and white pixels represent the extracted responses as logic “0” and logic “1”, respectively. FIG. 8 clearly shows that logic “0” and logic “1” are evenly distributed, and the probabilities of generating logic “0” and “1” are 49.92% and 50.08%, respectively. This indicates that the self-filtering monostable PUF circuit based on hysteresis effect according to the present invention still has good randomness after the addition of the filter unit.

Uniqueness measures the degree of difference between one PUF and another PUF, which is usually indicated by inter-chip Hamming distance. The inter-chip Hamming distance is calculated as follows:

$$H {D}_{i n t e r} = \frac{2}{n ( n - 1 )} {\sum }_{i = 1}^{n - 1} {\sum }_{j = i + 1}^{n} \frac{H D ( {R}_{i} , {R}_{j} )}{m} \times 100 \%$$

where n represents the number of PUF samples, HD (Ri, Rj) represents the Hamming distance between PUF responses i and j in any two PUF samples, and m represents the number of PUF response bits. Ideally, the uniqueness between any two PUF responses should be 50%.

Reliability measures the ability of a PUF to produce the same response to the same challenge under in the presence of noise, which is usually indicated by intra-chip Hamming distance. The intra-chip Hamming distance is calculated as follows:

$$H {D}_{i n t r a} = \frac{1}{n} {\sum }_{i = 1}^{n} \frac{H D ( {R}_{pi} , {R}_{q i} )}{m} \times 100 \%$$

where n represents the number of noise samples, HD (Rpi, Rpj) represents the Hamming distance between the response of PUF instance i over noise sample p and the response over noise sample q, and m represents the number of PUF response bits. Ideally, the intra-chip Hamming distance should be 0.

To test the uniqueness, the self-filtering monostable PUF circuit based on hysteresis effect according to the present disclosure was subjected to 20 Monte Carlo simulations at 27° C. and 1.2V. Based on the above 20 Monte Carlo simulations, reliability testing was performed. Ten noise tests were performed under each Monte Carlo condition, where the noise frequency was set to 100 MHz. The test results are shown in FIG. 9. From FIG. 9, it can be seen that the average inter-chip Hamming distance is 0.5050 and the average intra-chip Hamming distance is 0.0035, very close to the ideal values. This indicates that the self-filtering monostable PUF circuit based on hysteresis effect according to the present disclosure still has good uniqueness and reliability after the addition of the filter unit.

20 Monte Carlo simulations were performed on the self-filtering monostable PUF circuit based on hysteresis effect according to the present disclosure under the condition that the VDD was between 1.0V and 1.4V and temperature was between −40° C. and 120° C. The output value of the self-filtering monostable PUF circuit based on hysteresis effect according to the present disclosure at 1.2V and 27° C. was used as the standard value, and the PUF output values generated under other voltage and temperature conditions were compared with the standard value. Those PUF units of which the output values have never changed are regarded as stable bits, and those with changed output values are regarded as unstable bits. After filtering, the unstable-bit PUF units filtered out were masked and not counted in the BER (bit error rate). The masking rate is calculated as follows:

$$maked = \frac{n}{m} \times 100 \%$$

where n represents the number of unstable-bit PUF units filtered out, and m represents the number of PUF response bits. Because the hysteresis interval of the Schmitt trigger cannot accurately include the voltage distribution interval of an unstable-bit PUF unit, some unstable-bit PUF units inevitably fall outside the hysteresis interval and are tested as stable bits. Similarly, the output voltage value of a stable-bit PUF unit may also be included in the hysteresis interval, resulting in an error. The actual number of unstable-bit PUF units filtered out by the filter unit is counted, and the BER after filtering is compared with the native BER to reflect the performance of the filter unit. The improvement of the BER of the PUFs by the filter unit is represented by BER_{Imp}, which is calculated as follows:

$$B E {R}_{Imp} = \frac{B E {R}_{native} - BE {R}_{masked}}{B E {R}_{n a t i v e}}$$

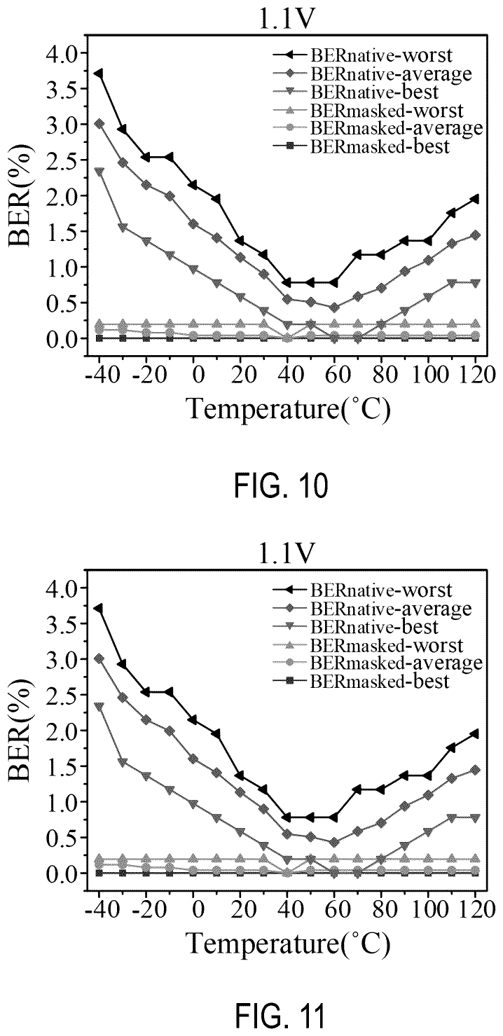

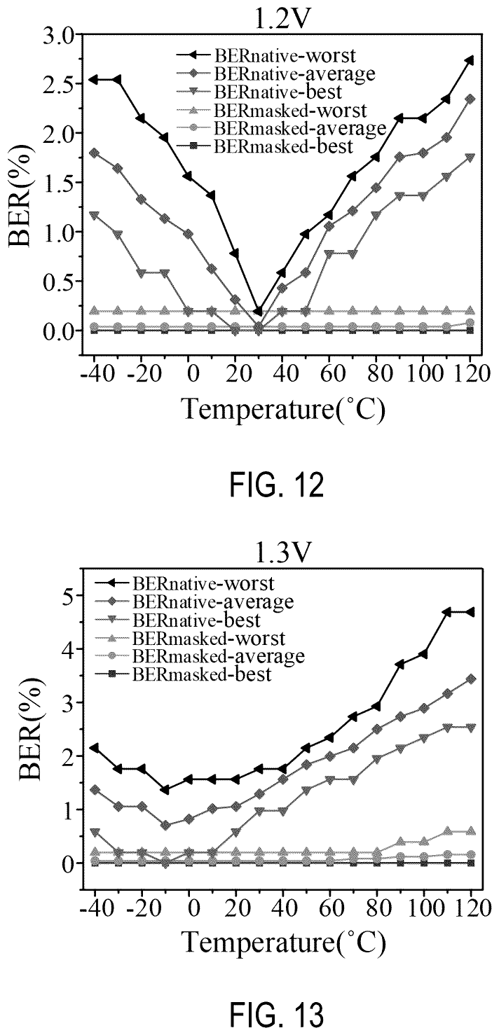

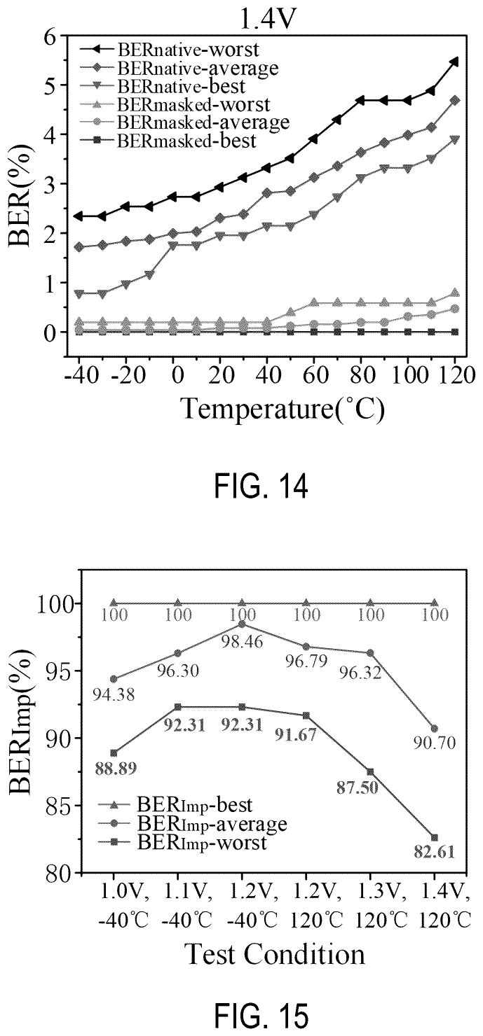

The filter unit filters the unstable bits at normal temperature and pressure (27° C. and 1.2V). The native BER and the BER after filtering under different voltage and temperature conditions are shown in FIGS. 10, 11, 12, 13 and 14, and the improvement of BER under extreme conditions is shown in FIG. 15. From FIGS. 10, 11, 12, 13, 14 and 15, it can be seen that under the voltage condition of 1.2V, the BER of the PUF is improved by more than 94.74% in the temperature range of −40° C. to 120° C.; under the two extreme temperature conditions of −40° C. and 120° C., the BER after filtering is reduced by 92.31% and 91.67% respectively in the worst case. Under the voltage conditions of 1.0V, 1.1V, 1.3V and 1.4V, the BER of PUF is improved by more than 87.5%, more than 95%, more than 88.46% and more than 84% in the temperature range of −40° C. to 120° C. respectively. In the four extreme conditions of 1.0V and −40° C., 1.1V and −40° C., 1.3V and 120° C., and 1.4V and 120° C., the worst case BER after filtering is reduced by 88.89%, 92.31%, 87.5%, and 82.61%, respectively. It can be seen that the filter unit has significantly improved the stability of PUF under extreme conditions. Overall, the BER is reduced by more than 91.89% in the voltage range of 1.0V to 1.4V and the temperature range of 0° C. to 100° C.; in the more extreme voltage range of 1.0V to 1.4V and the more extreme temperature range of −40° C. to 120° C., the BER is reduced by more than 88%. In the best case, all unstable bits can be filtered out. The average masking rate is 28.51%, and the minimum and maximum masking rates are 26.36% and 31.45%, respectively. It can be seen that the self-filtering monostable PUF circuit based on hysteresis effect according to the present disclosure greatly reduces the bit error rate and improves the stability significantly due to arrangement of the filter unit for filtering unstable PUF units.

What is claimed is:

1. A self-filtering monostable PUF circuit based on hysteresis effect, comprising a PUF unit array formed by n×m PUF units distributed in n rows and m columns, wherein n and m are integers greater than or equal to 1, the self-filtering monostable PUF circuit is characterized in that by adding a filter unit based on a Schmitt trigger, utilizing the hysteresis effect of the Schmitt trigger to efficiently self-filter the PUF units with unstable outputs to improve the overall stability of the PUF circuit.

2. The self-filtering monostable PUF circuit based on the hysteresis effect according to claim 1, characterized in that the filter unit comprises a first inverter, a second inverter, a third inverter, a 2-to-1 data selector and a Schmitt trigger, wherein each of the first inverter, the second inverter and the third inverter has an input terminal and an output terminal; the 2-to-1 data selector has two input terminals respectively referred as a first input terminal and a second input terminal, an output terminal and a timing control terminal; the Schmitt trigger has an input terminal and an output terminal; the input terminal of the first inverter is connected to the second input terminal of the 2-to-1 data selector, and a connection terminal thereof serves as an input terminal of the filter unit; the input terminal of the filter unit is configured to receive output responses generated by the PUF units; the output terminal of the first inverter is connected to the input terminal of the second inverter, the output terminal of the second inverter is connected to the input terminal of the third inverter, the output terminal of the third inverter is connected to the first input terminal of the 2-to-1 data selector; the output terminal of the 2-to-1 data selector is connected to the input terminal of the Schmitt trigger; the output terminal of the Schmitt trigger serves as an output terminal of the filter unit and the output terminal of the filter unit is configured to output a filter result; the timing control terminal of the 2-to-1 data selector serves as a timing control terminal of the filter unit to receive a high-level or low-level timing control signal.

3. The self-filtering monostable PUF circuit based on the hysteresis effect according to claim 2, characterized in that further comprising an input register, a timing controller, a row decoder, a column decoder and a transmission gate array, wherein the input register is configured to pre-store required row address data and column address data; the timing controller has an output terminal and is configured to generate a high-level timing control signal or a low-level timing control signal and output the signal via the output terminal thereof; the output terminal of the timing controller is connected to the timing control terminal of the filter unit; the row decoder has an input terminal and n-bit output terminals; the input terminal of the row decoder is connected to the input register to receive the row address data; the row decoder is configured to convert the row address data received by the input terminal thereof into n-bit row selection signals and output the n-bit row selection signals via the n-bit output terminals thereof in a one-to-one correspondence, wherein only one bit in the n-bit row selection signals is a high-level signal, and the other are low-level signals; the column decoder has an input terminal and m-bit output terminals, the input terminal of the column decoder is connected to the input register, the column address data is input in the input terminal of the column decoder, and the column decoder is configured to convert the column address data received by the input terminal thereof into m-bit column selection signals and output the m-bit column selection signals via the m-bit output terminals thereof in a one-to-one correspondence, wherein only one bit in the m-bit column selection signals is a high-level signal, and the other are low-level signals; the transmission gate array is formed by (n+1)×m transmission gates distributed in n+1 rows and m columns, each of the transmission gates has an input terminal, an output terminal and a control terminal, and under the control of a control signal received by the control terminal of the transmission gate, the input terminal and output terminal thereof are turned on or off; each of the PUF units has an output terminal for outputting the output response thereof; the kth bit output terminal of the row decoder is connected to the control terminal of m transmission gates located in row k, k=1, 2, . . . , n, the jth bit output terminal of the column decoder is connected to the control terminal of the transmission gate located in row n+1 and −2-column j, j=1, 2, . . . , m, the output terminal of the PUF unit located in row k and column j is connected to the input terminal of the transmission gate located in row k and column j, the output terminals of the n transmission gates located in rows 1 to n and column j are all connected to the input terminal of the transmission gate located in row n+1 and column j, and the output terminals of m transmission gates located in row n+1 are all connected to the input terminal of the filter unit.

4. The self-filtering monostable PUF circuit based on the hysteresis effect according to claim 3, characterized in that each of the PUF units comprises a first MOS, a second MOS, a third MOS and a fourth MOS, wherein the first MOS and the third MOS are PMOSs; the second MOS and the fourth MOS are NMOSs; the source of the first MOS and the source of the third MOS are connected to a power voltage (VDD); the drain and gate of the first MOS, the drain and gate of the second MOS, the gate of the third MOS and the gate of the fourth MOS are connected; the drain of the third MOS is connected to the drain of the fourth MOS, and a connection terminal thereof is the output terminal of the PUF unit; the source of the second MOS and the source of the fourth MOS are grounded; the first MOS and the second MOS constitute a first-stage inverter, and the third MOS and the fourth MOS constitute a second-stage inverter.

5. The self-filtering monostable PUF circuit based on the hysteresis effect according to claim 3, characterized in that each of the transmission gates comprises a fifth MOS, a sixth MOS, a seventh MOS and an eighth MOS, wherein the fifth MOS and the seventh MOS are PMOSs; the sixth MOS and the eighth MOS are NMOSs; the source of the fifth MOS is connected to the source of the sixth MOS, and a connection terminal thereof is the input terminal of the transmission gate; the drain of the fifth MOS is connected to the drain of the sixth MOS and a connection terminal thereof is the output terminal of the transmission gate; the gate of the fifth MOS, the drain of the seventh MOS and the drain of the eighth MOS are connected; the gate of the sixth MOS, the gate of the seventh MOS and the gate of the eighth MOS are connected, and a connection terminal thereof is the control terminal of the transmission gate; the source of the eighth MOS is grounded; the source of the seventh MOS is connected to the power voltage (VDD).

6. The self-filtering monostable PUF circuit based on the hysteresis effect according to claim 3, characterized in that the Schmitt trigger comprises a ninth MOS, a tenth MOS, an eleventh MOS, a twelfth MOS, a thirteenth MOS and a fourteenth MOS, wherein the ninth MOS, the tenth MOS and the thirteenth MOS are PMOSs; the eleventh MOS, the twelfth MOS and the fourteenth MOS are NMOSs; the source of the ninth MOS is connected to the power voltage (VDD); the gate of the ninth MOS, the gate of the tenth MOS, the gate of the eleventh MOS and the gate of the twelfth MOS are connected, and a connection terminal thereof is the input terminal of the Schmitt trigger; the drain of the ninth MOS, the source of the tenth MOS and the source of the thirteenth MOS are connected; the drain of the thirteenth MOS is grounded; the drain of the tenth MOS, the drain of the eleventh MOS, the gate of the thirteenth MOS and the gate of the fourteenth MOS are connected, and a connection terminal thereof is the output terminal of the Schmitt trigger; the source of the eleventh MOS, the drain of the twelfth MOS and the source of the fourteenth MOS are connected; the source of the twelfth MOS is grounded; the drain of the fourteenth MOS is connected to the power voltage (VDD).
